(19) United States
(12) Patent Application Publication
(10) Pub. No.: US 2006/0214843 A1
(43) Pub. Date: Sep. 28, 2006

(54) A Ground-Based or Airborne Scanning Radiometer with Precision All-Weather Calibration.

(76) Inventors: Marian Klein, Boulder, CO (US); Albin John Gasiewski, Boulder, CO (US)

Correspondence Address: INTELLIGENT MANAGEMENT SYSTEMS, LLC (IMS), 2501 N. GREEN VALLEY CIRCLE, SUITE 101-D, HENDERSON, NV, 89014, US

(21) Appl. No.: 10/907,258

(22) Filed: Mar. 25, 2005

(51) Int. Cl. G01S 3/02

(52) U.S. Cl. 342/351

(57) ABSTRACT

This invention describes a design of a structure that allows microwave radiometers to be calibrated under all conditions of weather and atmospheric fallout. The thermal emission standards radiating surfaces are kept free of hydrometeors (liquid water, ice, or snow), dust, dirt, soot, oils, ash, or other organic and inorganic matter during extended operation. Meanwhile, the radiometer are allowed an unobstructed view of scene under observation, for example, the entire sky from horizon to horizon as well as most of the ground underneath. The effects of any attenuating or scattering matter that accumulates on the elements of the beam forming system are compensated for since the thermal emission standards are viewed in front of the first element of beam forming system (e.g. lens, radome, protective window). In this manner the same amount of dirt, hydrometeors, etc. on radiometer first element of beam forming system as present during the viewing of the scene under observation will be present during calibration. The thermal emission standards' radiating surfaces are kept clean and free of attenuating or scattering matter, thus the precision, stability, and radiation characteristics of thermal reference are maintained.

### FEDERALLY SPONSORED RESEARCH

This invention was made with US Federal Government support. The Government has certain rights in this invention.

### FIELD OF INVENTION

This invention relates to automated operation of passive radiometers used to observe environmental parameters in the Earth's atmosphere under all conditions of weather and atmospheric fallout. The parameters of interest include temperature profiles, humidity profiles and path-integrated humidity amounts, cloud parameters, snow and rain properties, aircraft icing conditions, and trace gases. This invention also pertains to radiometers that could be used within the atmospheres of other bodies within the solar system, for example, Mars, for meteorological observations under all conditions of weather and atmospheric fallout. The invention is applicable to all radiometers that use some type of beam forming system and operating at optical, infrared, or microwave bands, including combinations of the above bands.

The invention is based on a passive radiometer used in either a fixed viewing angle mode or scanning mode, and requiring periodic calibration by being able to view one or more thermal emission standards. The problem with currently available radiometer systems used within the atmosphere, whether deployed at fixed ground sites, on a ship, or on an aircraft, is that these radiometers and their calibration elements accumulate hydrometeors (liquid water, ice, snow) in inclement weather, and dust, dirt, soot, oils, ash, or other organic and inorganic matter during extended operation. The accumulation of such matter on the radiometer beam forming system, whether the radiometers operate in the optical, infrared, or microwave portion of the electromagnetic spectrum, causes attenuation and scattering of the radiation being measured, thus resulting in erroneous measurements. Accumulation of such matter on the radiating surfaces of calibration elements causes similar measurement errors due to inaccurate calibration.

Terrestrial applications of environmental radiometers of the type related to our invention include long-term climatological measurements of said atmospheric parameters, initialization of numerical weather forecast models, aircraft icing detection, and satellite calibration and validation of satellite products. The worldwide development, production, and operation of such radiometers for environmental applications is believed to exceed U.S. $30M annually.

### BACKGROUND-PRIOR ART

In order to compensate for the effects of attenuating and scattering matter on the radiometer's beam forming elements, it is standard practice for the radiometer system to be designed so as to periodically view thermal emission standards. Periodic views of such standards also account for any changes in the response of the radiometers due to component drift and aging. Since radiometers typically must be sensitive to changes of as little as 0.1 Kelvin in radiation (or, “brightness”) temperature out of a total noise from both the scene and the radiometer electronics of 1,000 Kelvin or more, changes in the radiometers' gain of as little as one part in 10,000 (100 parts per million) can compromise measurement accuracy. However, thermal emission standards with as little as 0.1 K or better precision in the emission temperature from their radiating surfaces are readily produced. Periodic views of such standards by radiometers can be used to determine the gain and offset of the radiometer to the required precision, as discussed (for example) by Gasiewski and Kunkee [1993].

However, in order to provide calibration that is accurate enough for all environmental observation purposes the radiating surfaces of the thermal emission standards must also be kept free of any accumulating matter, just as required for the beam forming elements. In order to be effective in providing a well-determined amount of radiation into a radiometer the standards themselves are typically at least as large as the first element of the radiometers' beam forming system (i.e., the primary reflector, lens, radome, or window). In spite of their size, when not being used for calibration the standards can not block the radiometers' view of the environment. In addition, in order to retain precision in the amount of thermal emission produced by the standards they must be kept in a thermally stable enclosure free from damage by hail, human or animal activity, ash, or other fallout, or corrosive vapors. They must also be kept free of accumulation of liquid or frozen water on their radiating surfaces. The protective enclosure typically increases the effective size of the emission standards, thereby further compromising the radiometers' view of the environment.

Typical thermal emission standards use a highly absorbing material maintained at a well-determined and uniform temperature to produce a precisely known level of thermal (or, “blackbody”) radiation. The radiating material is typically a metallic surface painted with a black coating for an infrared system, a carbon-impregnated foam such as Echosorb™ from Emerson and Cummings, Inc., for a microwave system, or an array of aluminum pyramids or wedges covered with a thin absorbing coating of epoxy impregnated with iron particles (also available from Emerson and Cummings) for a microwave system. The radiating material can either be heated or cooled using a variety of means (electrical resistive heaters, thermoelectric coolers, flowing hot or cold liquids, or cryogenics). An insulating covering commonly made from foam is used to ensure uniformity of the temperature of the radiating material as well as minimize heat loss to or gain from the environment. At least a portion of the surface area of the insulating cover must be made from material that is transparent to radiation within the band in which the radiometer is sensitive so that measurement of the emitted radiation can occur.

Radiometers for environmental observation comprise a broad class of instruments. Commercial units include microwave, infrared, and optical types, as well as combinations of these individual types within modular units. In addition, such radiometers may be sensitive to environmental radiation at a number of frequencies within a number of bands in each of the optical, infrared, or microwave ranges. Despite their distinctions by frequencies of operation, most environmental radiometers have some type of beam forming system that varies in its design depending on the range of frequencies being observed and the specific application. In the microwave range the beam forming system typically consists of components such as lenses, feedhorns, orthogonal mode couplers, microstrip patches, grids, mirrors, focusing reflectors and subreflectors, dipoles, and radomes. Phased array beam forming [Skolnik, 1990] and aperture synthesis [Krauss, 1988] using a number of antenna and receiver elements are also used. In the optical and infrared ranges components such as lenses, mirrors, focusing reflectors, grids, gratings, apertures, irises, and transmission windows are commonly used. These components serve to define the angular pattern by which a radiometer is sensitive to radiation in the environment. The beam patterns are such that most of the sensitivity is concentrated within a narrow cone, but as a result of diffraction a significant amount of sensitivity also occurs outside of this cone in angular regions known as sidelobes [e.g. Silver (ed.), 1984; also Born and Wolf, 1980].

Radiometers provide measurements of the environmental radiation field by pointing (or steering) their beams in any of a number of angular directions. Many basic environmental radiation measurements are made by pointing the radiometer's beams in a single fixed direction in space (typically vertical), while more sophisticated systems scan the radiometer's beams in one or two dimensions sampling the radiation at a multiplicity of angles. Simple “scanning” radiometers provide additional information on the angular variation of the radiation field by steering the beam along one dimension of angular motion in a planar or conical pattern. In planar scanning systems the plane of scan is often coincident with either the elevation or azimuth plane, but tilted planes are also possible. More sophisticated “imaging” radiometer systems scan the radiometer's beams in two angular dimensions, for example, in both elevation and azimuth. Such a scanning technique is commonly used in weather radar to perform a “sector” scan of the atmosphere. In radiometry the scanning system may be either mechanical [e.g., Gasiewski et al., 1990] or electronic, as in a phased array system [Skolnik, 1990] or in aperture synthesis [Krauss, 1988].

In general, the wider the angular range of scan the less angular range there is left to provide the necessary views of thermal emission standards for calibration purposes. The need for providing an unobstructed view of the environment while being able to periodically view thermal emission standards housed in some form of protective enclosure, and thus free of accumulating matter, has heretofore presented significant system design challenges and has invariably resulted in compromised sensor capabilities. For example, if either a radome or transmission window are used to protect the beam forming and pointing mechanism the radome or window itself becomes subject to accumulation of attenuating and scattering matter. Even a thin (˜30 μm) layer of liquid or frozen water on a radome surface will seriously compromise the accuracy of a microwave radiometer. An even thinner (˜0.5 μm) layer of dust or soot on the protective window of an optical radiometer will seriously compromise its accuracy.

Blowers or other cleaning devices have been employed in attempts to maintain radome or window transmission characteristics, but the amounts of warm air needed from a blower for maintaining a hydrometeor-free radome, especially in snowing or raining conditions, and the relative low efficiency of a wiper mechanism in removing accumulated matter from an optical or infrared window to the degree required for environmental radiometry are prohibitive. Accordingly, it is impractical to use a radome or transmission window to protect both the beam forming elements and thermal emission standards while maintaining high radiometric precision under all conditions of weather and atmospheric fallout. While the attenuating and scattering effects of a clean radome or window can be well characterized during manufacture, it is difficult to accurately determine the transparency of such an exposed window on a regular basis during a long term deployment.

In contrast, if the thermal emission standards are positioned beyond the initial beam forming element in a radiometer system all of the attenuating and scattering effects of matter accumulating on the beam forming elements can be compensated for through the calibration process. However, in this case the emission standards themselves are subject to accumulation of attenuating and scattering matter on their radiating surfaces, unless otherwise protected by a suitable clean and environmentally benign enclosure. Such enclosures can be fabricated and kept clean, thermally and moisture stabilized, and free of debris and damaging human and animal activity and atmospheric fallout. However, such calibration enclosures also limit the angular range that can be viewed by the radiometer itself, thereby compromising the amount of environmental data that can be measured.

Our invention circumvents the combined problems of wide-angle viewing, protection of calibration standards, and calibration of all of the attenuating and scattering effects of all beam forming elements by including a means of translating the radiometer module outside of the enclosure of the thermal emission standards so as to provide an unobstructed view of the environment. The emission standards thus remain in a protected environment, the radiometer is provided with an unobstructed view of the environment, and same attenuating and scattering characteristics of the beam forming system are present during both environmental measurement and calibration.

Since accumulating debris generally precipitates downward it is important to face the radiating surfaces of the thermal emission standards in a general downward direction so as to prevent accumulation of attenuating and scattering matter on their radiating surfaces. Placing thermal standards in a downward facing configuration can seriously compromise the range of angles in the sky that can be viewed by an atmospheric environmental radiometer system, especially since most such systems need to view in the vertical direction, scan about the vertical direction, or both for most atmospheric measurement purposes. The above compromising principal applies equally to ground-based, ship-borne, and airborne radiometers that require views or scanning at any angles above the horizon. Our invention solves the problem of viewing the sky while simultaneously facing the thermal emission standards downwards by translating the radiometers along with their beam forming and (if applicable) scanning system out from underneath the standards so to provide an unobstructed view of the environment.

In prior practice, commercial radiometer systems have been deployed that use only one thermal emission standard. Use of only one thermal emission standard serves to alleviate the basic problem associated with occultation of the radiometer beam by the standard, but provides only one observation by which to identify two time-varying calibration parameters (a gain, or sensitivity, and an offset, or bias). As discussed above, radiometers for environmental measurement require some method of frequent, precise, and absolute calibration that compensates for the effects of all mechanisms that could change both the gain and offset of the system. With only a single thermal emission standard calibration thus becomes influenced by questionable presumptions about the stability of various components. When using only one thermal emission standard an additional independent datum is required to unambiguously determine both the gain and offset.

Such a second calibration datum can be provided by observing the atmosphere at a number of angles relative to the zenith direction. This “tip calibration” technique [Han and Westwater, 2000] relies on being able to view the atmosphere at a number of discrete angles out to nearly 70 degrees from zenith. It also relies on the stratification of the atmosphere and the relative transparency of the atmosphere. Under these conditions it can be used to identify one of either the unknown gain or offset of the radiometer system. Since an entire radiometer system (including beam forming mechanism and window or radome) can be tipped to implement this technique, the effects of accumulating matter adhering to the window or radome can be compensated.

In spite of its utility in providing an additional calibration datum the method of tip calibration can only be used in favorable stratified atmospheric conditions which rarely occur when clouds, rain, or snow are present. In addition, since a significant change of radiation is necessary during tip calibration the technique cannot be used for frequencies that are either very opaque or very transparent within the atmosphere. Thus, its application to circumventing the essential calibration problem that our invention solves is limited.

Calibration of radiometers is also often performed using only internal sources of radiation, for example, electronic or thermal noise noise sources injected into the radiometer after the beam forming system [Corbella, et al., 2002]. However, internal calibration techniques have significant limitations. Most importantly, the internal calibration process does not compensate for variations in the gain or offset introduced by the beam forming mechanism, and especially the first elements in the beam forming system (i.e. in the lens, window, or radome). Thus, internal calibration cannot circumvent the essential problem of accumulating matter on the beam forming elements.

### OBJECTS AND ADVANTAGES

Our invention overcomes all of the above-mentioned problems associated with the need to provide accurate periodic calibration of a radiometer at a stage in front of its beam forming system under all conditions of weather and atmospheric fallout. Our system can provide calibration as often as desired with the radiating surfaces of the calibration targets always remaining clean, safe from damage, free of liquid or frozen water accumulation, and thermally stable while the radiometer beam forming system can provide scanned or fixed views toward any part of the environment. The effects of any attenuating or scattering matter that accumulates on the elements of the beam forming system will be compensated for since the thermal emission standards are viewed in front of the first element of the beam forming system. In this manner the same amount of dirt, soot, oils, hydrometeors, etc., present on the radiometer antenna or lens elements during viewing of radiation from the environment will also be present during calibration. When used with at least two thermal emission standards radiating at two distinct temperatures the technique provides at least two independent calibration data points that can be used to unambiguously identify both the radiometer gain and offset. Since the technique does not rely on tip calibration it works for both extremely opaque and extremely transparent frequencies as well at all partially-transparent frequencies, and does not require any prescribed degree of atmospheric stratification.

Our radiometer system uses thermal emission standards that are protected from hydrometeors or other falling atmospheric matter or other debris while simultaneously oriented in approximately a downward facing direction. Accordingly, there is negligible opportunity for hydrometeors (water or ice), chemicals, dust, dirt, or debris to collect on the radiating surfaces of the standards. Moreover, the targets are protected from the influence of the environment, including high winds, human and animal activity and environmental debris, by an enclosed structure with a doorway that keeps the structure closed off to the environment for most of the time.

The essential principle is as follows: a translational motion system moves a module that comprises the radiometer and its beam forming system and (if applicable) scanning mechanism from underneath the calibration targets to its environmental viewing position where it can be scanned without any obstruction from the thermal emission standards or their enclosure. A door on both sides of the radiometer module provides a seal over the hole in the enclosure when the module is either fully inside (for calibration) or fully outside (for viewing the environment). Using this arrangement the thermal emission standards will be exposed to the outside environment for only a small interval of time during which the radiometer module is being moved in or out of the enclosure.

The radiometer module can be comprised of either a scanning system that views over a multiplicity of angles or a fixed-beam unit that views in only one angular direction. If the radiometer module is a fixed-beam unit and more than one thermal emission standard is used it will be required to have at least some motional capability so as to be able to view all of the thermal standards within the calibration enclosure. If the radiometer module is a scanning unit the thermal emission standards would be viewable by sequentially training the radiometer beams in the directions of the standards.

A scanning radiometer module can be comprised of a rotating drum or other housing containing one or more radiometers operating at one or more bands, including microwave, optical, and infrared radiometers. If multiple bands are used the design of the thermal emission standards may have to be segmented or several standards installed so that each radiometer can be calibrated according to its band of sensitivity. Alternately, the scanning radiometer module can be comprised of a radiometer or set of radiometers that are scanned by a movable mirror. Such a “cross-track” scanning scheme is used in various commercial radiometer systems, commonly known as “mailbox” radiometers, and available from Radiometrics, Inc. These systems use a flat or offset parabolic mirror driven by a motor to scan the beam over a sector within in a plane, providing in addition a view of at least one protected thermal emission standard. A radome is used along with a blower to attempt to keep the radome free of hydormeteors and debris. The system uses a single thermal emission standard since use of a second thermal emission standard for all-weather calibration compromises the ability to scan over a wide angular range. The radome may also have spatial variations in its transmission characteristics that compromise the accuracy of the radiometer over the entire range of scan along with compromising the potential use of tip calibration. For these reasons the mailbox radiometer is considered insufficient to accurately observe environmental radiation field for may applications under all weather conditions, but could be used as the radiometer module within our scheme.

### SUMMARY

The proposed invention permits calibration of radiometers as often as required to compensate for changes in their response while maintaining the precision of the thermal emission standards under all conditions of weather and atmospheric fallout. Radiometers are provided an unobstructed view of the environmental radiation field. The effects of any attenuating or scattering matter accumulated on any beam forming element, including lenses, windows, and radomes, are compensated for during calibration since the thermal emission standards are placed in front of the first element of beam forming system. That is, the entire optical pathway through the beam forming system is accounted for in the calibration process. The radiating surfaces of the thermal emission standards are kept isolated from the environment and clean and free of any attenuating or scattering matter, thus the precision, stability, and radiation characteristics of thermal emission references are maintained.

Definition List 1

| Term | Definition |
|---|---|
| 20 | Thermal emission standard 1 |
| 22 | Thermal emission standard 2 |
| 24 | Translating Mechanism |
| 26 | Radiometer Module |
| 28 | Radiometer Antennas or Lenses |
| 30 | Enclosure |
| 32 | Door |

### DETAILED DESCRIPTION AND OPERATION

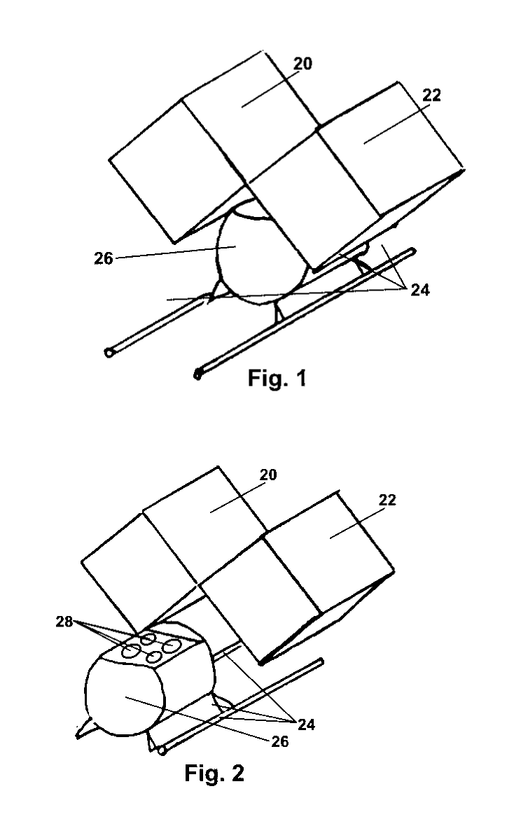

The principle of our invention is shown by the embodiment in FIGS. 1 through 4. FIG. 1 shows a radiometer unit within position for calibration. In order to explain the principle of operation in this view the enclosure protecting the thermal emission standards 20 and 22 is not shown. The radiometers and supporting electronics are located in a movable protective housing called the radiometer module 26. This module scans the radiometer beams in elevation and thus is able to point the radiometer antennas 28 (shown in FIG. 2) to any elevation angle. Alternatively, the scanning radiometer module can be a static unit which points the beams only in a fixed direction when viewing the environment, or it can scan the radiometer beams by using a mechanically scanned mirror or electrically scanned means such as a phased array. For calibration, FIG. 1, the scanning radiometer module 26 is inside of the enclosure for the thermal emission standards. The translating mechanism 24 moves the radiometer module 26 in and out of the calibration position. When in calibration position, radiometers antennas 28 are sequentially trained to each thermal emission standard 20 and 22 for a predefined duration of time. Measurements of the emission from each standard are recorded during these times.

FIG. 2 shows the radiometer module in the position for observging the environment. The radiometer module 26 is positioned by the translating mechanism 24 far enough from the thermal emission standards 20 and 22 such that each radiometer beam is separated from the standards so as to have an unobstructed view of the environment, e.g. the sky above or the terrain or ocean surface below. By far enough it is presumed that any stray radiation measured through the radiometers' sidelobes of its antenna beam are negligible relative to the required system accuracy, as can be verified by knowledge of the sensitivity pattern of the radiometer.

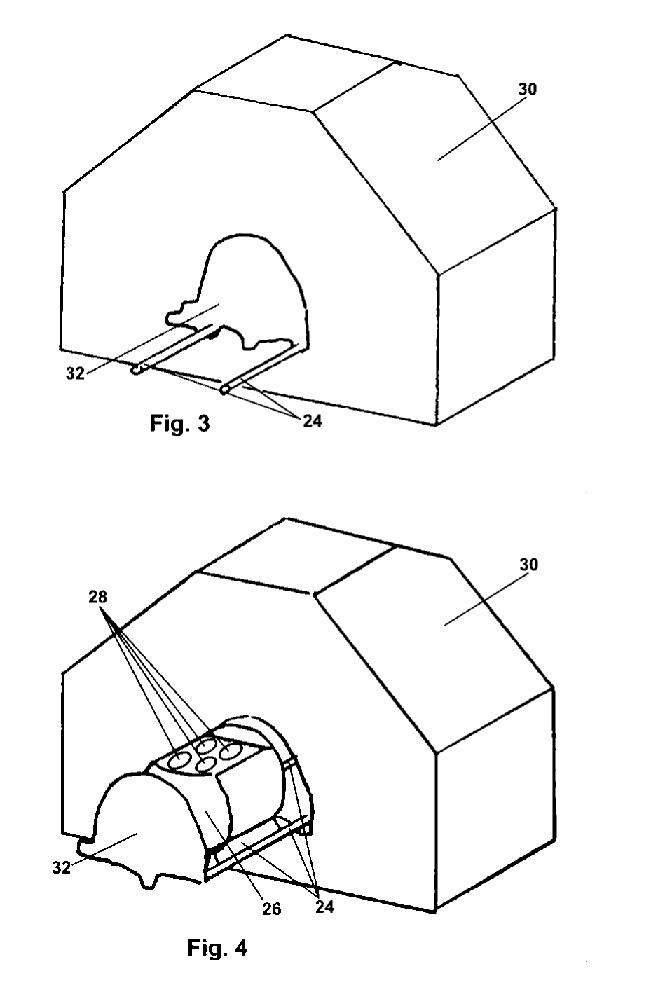

The radiating surfaces of the thermal emission standards 20 and 22 are always protected by an enclosure 30 from all weather conditions and atmospheric fallout. The function of the protective enclosure is illustrated in FIG. 3. A protective door 32 seals the enclosure 30 during calibration. Parts of the translating mechanism 24 remain visible.

FIG. 4 shows the radiometer module 26 in its observing position, and illustrates the calibration enclosure 30. The scanning radiometer module 26 is shown completely outside of the calibration enclosure. The radiometer antennas 28 view the environment without obstruction by any part of the instrument. The radiometer module 26 is moved by a translating mechanism 24 far in order for the sidelobes of each radiometer beam to have a negligible influence on the observed data. It is also possible to design the wall of the enclosure 30 from which the radiometer module enters and exits the enclosure from material that will reflect the radiometer beam sidelobes and project them back into the environment toward the observed scene. What is not visible on FIG. 4 is an additional door similar to door 32 but behind the radiometer module that closes the calibration enclosure during the environmental observing period. This second door provides additional protection of thermal emission standards 20 and 22 from environment during the environmental observation period.

The above embodiment of a radiometer system for environmental observation was successfully demonstrated during a continuous month of operation in the Arctic winter of 2004 [Westwater et. al, 2004]. Accordingly, the essential attribute of all-weather operation using our invention has been reduced to practice.

### CONCLUSION, RAMIFICATIONS, AND SCOPE

While the above embodiment of our invention contains many specifics, these should not be construed as limitations to the scope of the invention, but rather as an exemplification of one embodiment thereof. Many other variations are possible. For example, any kind of relative movement of the thermal emission standards 20, 22 with respect to radiometer module 26, could provide the same results. Furthermore, the translation mechanism 24 could be any mechanism that will permit and facilitate relative motion of the standards 20, 22 with respect to the radiometer module 26. The radiometer module 26 might not be a mechanically scanned unit, but rather the beams of radiometers could be steered through the observed scene by several other mechanical or electronic means. The steering of the beams could be in one or two dimensions. The overall system embodied as the result of our invention could be installed on an airplane (for example within a fuselage or wing pod), a ship, a truck, or train, in which case the embodiment may appear different. Accordingly, the scope of the invention should be determined not solely by the embodiment illustrated, but by the appended claims and their legal equivalents.

The impact of our invention will be improvements in the accuracy of environmental radiometric observations, which in turn will impact the accuracy of climate observations, studies of the effects of clouds and water vapor on climate, calibration and validation of weather satellites using independent sensors, weather forecasting, and improved observations of water fluxes and water resources.

### REFERENCES

Ulaby, Fawwaz T., R. K. Moore, and Adrian K. Fung, Microwave Remote Sensing—Active and Passive, vol. I: Fundamentals and Radiometry, Artech House, Inc., Norwood, Mass., 1981.
Born, M., and E. Wolf, Principles of Optics, Pergamon Press, Oxford, England, 1984.
Silver, S. (ed.), Microwave Antenna Theory and Design, Peter Peregrinus, Ltd., London, U.K., 1984.
Krauss, John D., Radio Astronomy (2nd ed.), Cygnus-Quasar Books, Powell, Ohio, 1988.
Skolnik, M., Radar Handbook, 2nd Edition, McGraw-Hill, Boston Mass., 1990.
Gasiewski, A. J. Barrett, J. W., Bonanni, P. G., and Staelin, D. H., “Aircraft-Based Radiometric Imaging of Tropospheric Temperature Profiles and Precipitation Using the 118.75-GHz Oxygen Resonance,” J. Appl. Meteor., vol. 29, no. 7, pp. 620-632, July 1990.
Gasiewski, A. J. and Kunkee, D. B., “Calibration and Applications of Polarization Correlating Radiometers,” IEEE Trans. Microwave Theory Tech., vol. 41, no. 5, pp. 767-773, May 1993.
Han, Y., and E. R. Westwater, “Analysis and Improvement of Tipping Calibration for Ground-Based Radiometers,” IEEE Trans. Geosci. Remote Sensing, vol. 38, no. 3, pp. 1260-1276, May 2000.
Corbella, I., A. J. Gasiewski, M. Klein, V. Leuski, A. J. Francavilla, and J. R. Piepmeier,
“On-board Accurate Calibration of Dual-Channel Radiometers Using Internal and
External References,” IEEE Trans. Microwave Theory Tech., vol 50, No. 7, pp. 1816-1820, July 2002.
Lahtinen, J., A. J. Gasiewski, M. Klein, and I. Corbella, “A Calibration Method for Fully Polarimetric Radiometers,” IEEE Trans. Geosci. Remote Sensing, vol. 41, no. 3, pp. 588-602, March 2003.
Westwater, E. R., M. Klein, V. Leuski, A. J. Gasiewski, T. Uttal, D. A. Hazen, D. Cimini, V. Mattioli, B. L. Weber, S. Dowlatshahi, J. A. Shaw, B. Zak, J. C. Liljegren, B. M. Lesht, “The 2004 North Slope of Alaska Artic Winter Radiometric Experiment”, Fourteenth ARM Science Team Meeting Proceedings, Alberquerque, N. Mex., Mar. 22-26, 2004.

What is claimed is:

1. A passive radiometer system for operation within an atmosphere that provides unobstructed viewing of the environment's radiation field along with calibration of the system's radiometers under nearly all conditions of weather and atmospheric fallout, comprising:
means for forming and pointing the radiometer beams in one or more viewing modes, including any of the following: an elevation scan over a range of angles up to a full circle; an azimuth scan over a range of angles up to a full circle; a two-dimensional scan using a combination of elevation and azimuth angles; a fixed viewing angle or set of angles; a stepwise scan over a discrete set of azimuth, elevation, or azimuth and elevation angles; and
means for calibrating each radiometer accounting for the attenuating and scattering effects of all reflecting, refracting, diffracting, and protective elements of each radiometer's beam forming and pointing system by periodically training the radiometer beams on one or more thermal reference standards while simultaneously measuring the radiometer output; and
means for maintaining the precision of said thermal reference standards by protection from external environmental influences; and
means for rapidly moving (a) the radiometer assembly consisting of said radiometers, beam forming, and beam pointing apparatus and (b) the thermal reference standards relative to each other so as to provide an unobstructed view of the environment by the radiometers over any predetermined viewing mode.

2. The passive radiometer system of claim 1 further comprising:
any number of thermal reference standards located within a housing or fuselage possessing any of the following attributes so that accumulation of attenuating or scattering matter on their radiating surfaces is prevented: free of loose environmental debris and hydrometeors including rain; snow; ice; fog; clouds; condensing vapors; corrosive vapors; dirt; dust; soot; and organic matter; incorporating one or more doors used to seal the hole in the enclosure through which said radiometer assembly passes.

3. The passive radiometer system of claim 1 further comprising:
any number of thermal reference standards located within a housing or fuselage providing interior temperature regulation so that accumulation of liquid and frozen water on their radiating surfaces is prevented.

4. The passive radiometer system of claim 1 further comprising:
any number of thermal reference standards located within a housing or fuselage providing interior moisture regulation by any of the following means so that accumulation of liquid and frozen water on their radiating surfaces is prevented: dry gas purge; air conditioning; blowers; and desiccation.

5. The passive radiometer system of claim 1 further comprising:
any number of thermal reference standards with their radiating surfaces oriented in a generally downwards direction so that the gravitational accumulation of attenuating or scattering matter on their radiating surfaces is prevented.

6. The passive radiometer system of claim 1 operated on an aircraft and further comprising:
any number of thermal reference standards with their radiating surfaces oriented in a generally aft direction so that the radiating surfaces are protected from the impingement and accumulation of atmospheric matter or other debris.

7. The passive radiometer system of claim 1 further comprising:
at least one thermal reference standard along with at least one additional means of determining the gain and offset of each radiometer from the following established methods: calibration using internal noise sources, for example, as taught by Corbella et al. [2002]; tipping calibration, for example, as taught by Han and Westwater [2000]; feedback null noise injection as taught by Ulaby et al. [1981]; Dicke switching; noise diodes; low-loss input switches; homodyne detection; cold thermal sources using amplifier inputs; correlated noise sources; waveguide terminations; and transmission line terminations.

8. The passive radiometer system of claim 1 further comprising:
at least one polarimetric radiometer being able to sense radiation in more than one of the four fundamental polarization states; and
at least one polarized thermal emission standard as taught by Gasiewski in U.S. Pat. No. 5,231,404.

9. The passive radiometer system of claim 1 further comprising:
at least one polarimetric radiometer being able to sense radiation in more than one of the four fundamental polarization states; and
at least one polarized thermal emission standard as described by Lahtinen et al. [2003].

10. The passive radiometer system of claim 1 further comprising:
a beam forming system using optical components including: lenses; fixed mirrors; scanning mirrors; fixed focusing reflectors; scanning focusing reflectors; subreflectors; grids; gratings; and windows.

11. The passive radiometer system of claim 1 further comprising:
a beam forming system using microwave components including: lenses; feedhorns; orthogonal mode couplers; microstrip patches; dipoles; radiating element arrays; fixed mirrors; grids; scanning mirrors; fixed focusing reflectors; scanning focusing reflectors; subreflectors; phase shifters; and radomes.

12. The passive radiometer system of claim 1 further comprising:
a beam forming system using aperture synthesis, as taught by Krauss [1986] and of any of the following types: one-dimensional; and two dimensional.

13. The passive radiometer system of claim 1 further comprising:
additional reflecting, refracting, diffracting, or protective elements beyond said beam forming and pointing system to provide additional means of beam focusing and pointing and for which the gain and offset variations are not accounted for by the said calibration means.
